(19) United States
(12) Patent Application Publication
(10) Pub. No.: US 2009/0045253 A1
(43) Pub. Date: Feb. 19, 2009

(54) SYSTEM AND METHOD FOR PROVIDING VIRTUAL DISCERNMENT INFORMATION

(76) Inventor: Min Gyu Han, Seoul (KR)

Correspondence Address: HAMMER & ASSOCIATES, P.C., 3125 SPRINGBANK LANE, SUITE G, CHARLOTTE, NC, 28226, US

(21) Appl. No.: 12/282,221

(22) PCT Filed: Mar. 12, 2007
(86) PCT No.: PCT/KR07/01199

§ 371 Date: Sep. 9, 2008

(30) Foreign Application Priority Data
Mar. 10, 2006 (KR) 10-2006-0022621
Apr. 20, 2006 (KR) 10-20060035578
Mar. 12, 2007 (KR) 10-2007-0024102

(51) Int. Cl. G06K 5/00

(52) U.S. Cl. 235/380

(57) ABSTRACT

A system and method of providing virtual identification information which can securely perform a predetermined control process online or offline using virtual identification information, without directly exposing personal information, is provided. The method of providing virtual identification information includes: exposing an output medium having an identification code to a user being associated with a request of the user; receiving personal information of the user along with the identification code from the user; generating virtual identification information using the inputted identification code and personal information, and transmitting the generated virtual identification information to the user; and performing a predetermined control process which corresponds to a request of the user as a result that the transmitted virtual identification information is inputted to the exposed output medium by the user.

### TECHNICAL FIELD

The present invention relates to a system and method of providing virtual identification information which can be securely performed using virtual identification information, which is generated by transforming personal information of a user, and accordingly, the personal information of the user is not directly exposed online or offline via a predetermined control process, which is required by the user.

### BACKGROUND ART

FIG. 1 is a flowchart illustrating a method of joining an Internet site using a resident registration number according to a conventional art.

In operation 101, a user inputs a resident registration number on a member joining page to join the Internet site, and clicks a button to verify personal identity. The user accesses to the Internet site using Internet accessible devices such as a personal computer (PC), a personal digital assistant (PDA), and a mobile terminal, and moves to the member joining page, and inputs the resident registration number. In this case, the user inputs a user's name along with the resident registration number.

In operation 102, the Internet site checks whether the inputted resident registration number is valid. The year, month, and date of birth, a gender, a location of birth registration, and a verification number are included in the resident registration number, and the verification number is generated by applying an upper twelve figures of the resident registration number to a specific formula. Accordingly, the Internet site may check validity of the resident registration number using the upper twelve figures and a last verification number.

In operation 103, the Internet site verifies personal identity using a personal identification verification database when the inputted resident registration number is valid. After the Internet site checks whether the inputted resident registration number corresponds to the user's resident registration number using a name of the user and the resident registration number of the user, as a result of the verification, the Internet site may approve of the user's joining the Internet site. Also, the Internet site may request the user to input the resident registration number again when the resident registration number is not valid.

In operation 104, the Internet site terminates the joining process of the member after the personal identity is verified. In this case, the Internet site may approve of the user's joining after being inputted further information such as a user identification (ID), a password, an address, a telephone number, and military service status, and after storing the further information in association with the resident registration number.

As described above, since personal information such as data of birth, address, educational background, blood type, military service status, marital status, delivery, and date of death are included in the resident registration number, when the resident registration number is unlawfully distributed, huge damages may occur. Particularly, with development of Internet technology, a user is required to join an Internet site to acquire required information, accordingly the user can not help exposing the user's resident registration number.

Currently, there are occurrences where unlawful distribution of exposed resident registration numbers occurs when a user joins an Internet site as a member. For example, the user may be joined as a member of another fee-based site without realizing it. Also, the joined Internet site may unlawfully collect other information from the exposed resident registration number. Also, it is increasingly occurring that an Internet site sells joined members' resident registration numbers, or that the Internet site may promote sales or deceive joined members using members' resident registration numbers.

### DISCLOSURE OF INVENTION

### Technical Goals

The present invention provides a system and method of providing virtual identification information which provides an environment capable of securely performing various control processes being required by a user using virtual identification information, having been generated by transforming personal information of the user, without directly exposing the personal information.

The present invention also provides a system and method of providing virtual identification information which can reduce damages of personal information being easily stolen since virtual identification information is inputted instead of actual personal information, which is required to be inputted when verifying a personal identification online.

The present invention also provides a system and method of providing virtual identification information which can securely perform a control process using virtual identification information offline as well as online since the virtual identification information is generated using an identification code, which is allocated to a member store, a terminal of the member store, a server of the member store, or a service of the member store offline, and the generated virtual identification code is provided to a user.

### Technical Solutions

According to an aspect of the present invention, there is provided a method of providing virtual identification information including: exposing an output medium having an identification code to a user being associated with a request of the user; receiving personal information of the user along with the identification code from the user; generating virtual identification information using the inputted identification code and personal information, and transmitting the generated virtual identification information to the user; and performing a predetermined control process which corresponds to a request of the user as a result that the transmitted virtual identification information is inputted to the exposed output medium by the user.

According to another aspect of the present invention, there is provided a system of providing virtual identification information including: an output control unit exposing an output medium having an identification code to a user being associated with a request of the user; an information receiving unit receiving personal information of the user along with the identification code from the user; an identification information generation unit generating virtual identification information using the inputted identification code and personal information, and transmitting the generated virtual identification information to the user; and a control process unit performing a predetermined control process which corresponds to a request of the user as a result that the transmitted virtual identification information is inputted to the exposed output medium by the user.

### BRIEF DESCRIPTION OF DRAWINGS

FIG. 1 is a flowchart illustrating a method of joining an Internet site using a resident registration number according to a conventional art;

FIG. 2 is a diagram briefly illustrating a network configuration of a system of providing virtual identification information according to the present invention;

FIG. 3 is a diagram illustrating a detailed configuration of a system of providing virtual identification information according to an embodiment of the present invention;

FIG. 4 is a diagram illustrating an example of the identification code database of FIG. 3 and the identification information database of FIG. 3 according to the present invention;

FIG. 5 is a diagram illustrating an example of performing a control process, which is required by a user, using virtual identification information of the present invention;

FIG. 6 is a flowchart illustrating a method of providing virtual identification information according to an embodiment of the present invention;

FIG. 7 is a diagram illustrating a network connection of a system of providing virtual identification information according to another embodiment of the present invention;

FIG. 8 is a block diagram illustrating a configuration of a system of providing virtual identification information according to an embodiment of the present invention;

FIG. 9 is a flowchart illustrating a method of providing virtual identification information according to an embodiment of the present invention;

FIGS. 10 through 13 are flowcharts illustrating a method of verifying a user according to an embodiment of the present invention;

FIG. 14 is a flowchart illustrating a method of verifying virtual identification information according to an embodiment of the present invention;

FIGS. 15 through 17 are flowcharts illustrating a method of providing virtual identification information according to another embodiment of the present invention;

FIG. 18 is a block diagram illustrating a configuration of a system of providing virtual identification information according to another embodiment of the present invention; and

FIG. 19 is a flowchart illustrating a method of providing virtual identification information according to still another embodiment of the present invention.

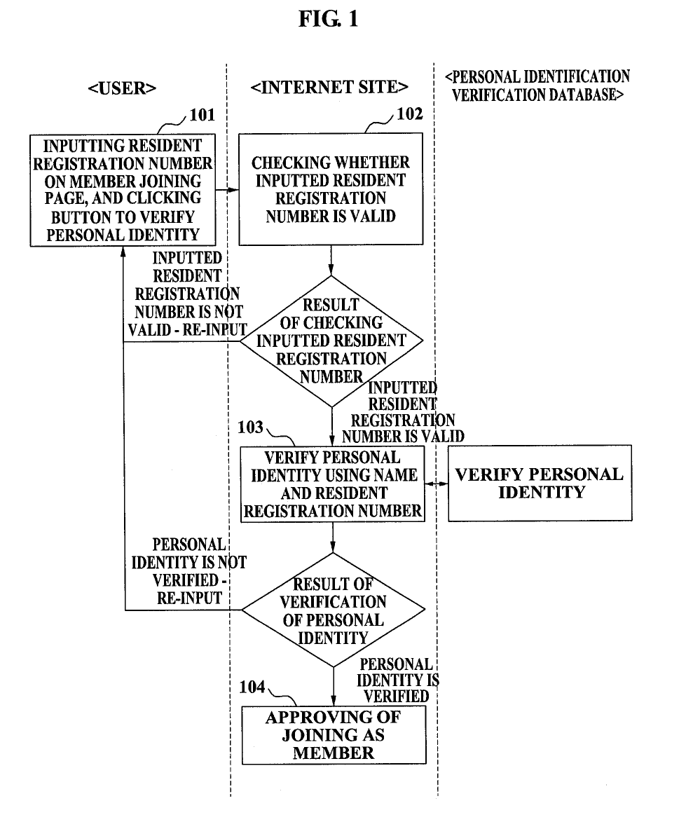

### BEST MODE FOR CARRYING OUT THE INVENTION

Hereinafter, embodiments of the present invention will be described by referring to the accompanying drawings.

‘Virtual identification information’ which is used throughout the specification is a type of information which is generated by transforming personal information, and indicates virtual identification information which includes information capable of identifying a personal identity, and also is identified as arrays of meaningless codes to other users even when unlawful distribution of the personal information occurs.

Specifically, the present invention may prevent an illegitimate use of the virtual identification information due to an unlawful distribution since virtual identification information is generated and provided to a user by individually corresponding a control process to be performed by a user, e.g. member joining for an online service and a product purchase offline, associated with a request of the user. That is, in the present invention, damages due to an unlawful distribution may be minimized even when virtual identification information is unlawfully distributed since disposable virtual identification information may be generated, the disposable virtual identification information being valid within a limitation of a specific user's a specific request with respect to a specific member store, a server of the specific member store, or a terminal of the specific member store.

Also, an identification code associated with generating of virtual identification information may be allocated to the terminal of the member store where a request of the user is inputted, according to a predetermined agreement, and an owner of the member store may enable the user to use the virtual identification information by exposing the identification code to the user, subsequently the generating of the virtual identification information capable of easily replacing personal information using the identification code is induced.

Accordingly, by using the generated virtual identification information, the user may prepare an environment capable of securely performing the control process which corresponds to the request of the user from a corresponding member store without exposing user's personal information, such as a resident registration number, a credit card number, a driver's license number, a tax payment number, a medical insurance number, and a social security number.

Also, the method of providing virtual identification information of the present invention may be flexibly applied to a control process offline in addition to online since the virtual identification information is generated using an identification code allocated to a service of the member store or a terminal of the member store, which can be equipped offline, and the generated virtual identification information is provided to a user.

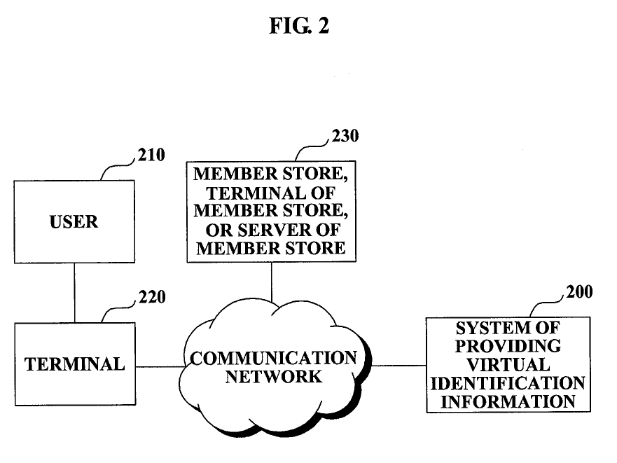

FIG. 2 is a brief diagram illustrating a network configuration of a system of providing virtual identification information 200 according to the present invention.

The system of providing virtual identification information 200 according to the present invention, with respect to a request of a user 210, generates virtual identification information corresponding to the request to provide the user 210 with the generated virtual identification information, as a result that the user 210 inputs the provided virtual identification information to a predetermined output medium, verification is performed with respect to the virtual identification information, and a normal control process is performed with respect to legitimately inputted virtual identification information.

The user 210 may be an Internet user online or a product purchaser offline who uses the virtual identification information of the present invention in order to perform a required control process. The control process may include various processes online and offline, such as a member joining process for a specific service server, and an e-commerce process for processes online, and a product purchase process, a card member joining process, and a predetermined contract conclusion process for processes offline. That is, a control process which is used throughout the specification of the present invention may denote all kinds of processes which directly request the personal information of the user 210, including control processes online and offline. However, hereinafter, descriptions will be made by being limited to a case that the personal information of the user 210 is requested while the user 210 purchases a predetermined product offline, for convenience of description.

A terminal 220 is a device having a function of wired/wireless communication, the device being owned by the user 210, and may include a mobile communication terminal, a wired telephone, an IP telephone, a personal digital assistant (PDA), a personal computer, and the like. Hereinafter, descriptions will be made by being limited to a mobile communication terminal, having been allocated a unique identification number, i.e. a mobile phone.

A terminal 230 of a member store indicates a terminal in a member store receiving a request of the user 210, the terminal having functions of requesting generation of virtual identification information, of being inputted an virtual identification number from the user 210, of requesting verification with respect to the inputted virtual identification information, of receiving a result of the verification, and the like.

Specifically, the terminal 230 of the member store exposes an output medium having an identification code to the user 210 being associated with a request of the user 210, the user 210 identifies the identification code which is allocated to the terminal 230 of the member store, the user 210 may use the identification code, and consequently the virtual identification information of the present invention is easily generated, which will be described later.

In this instance, the identification code may be a special service code or a terminal identifier, the special service code being independently allocated to the terminal 230 of the member store or to the member store, and being used for a mobile originated (MO) service using a short message service (SMS) or an automatic response system (ARS). The user 210 may requests generation of the virtual identification information using the identification code. Contrary to the terminal identifier which possibly corresponds to arrays of a plurality of codes, the special service number may correspond to a collection of short codes, which is easily identified. As an example, the special service number may be allocated to the terminal 230 of the member store in which a requests of a user frequently occurs by replacing a unique terminal identifier, and may correspond to a collection of fewer numbers.

As an example, when the special service code of the shortened telephone number is allocated as the identification code, the user 210 inputs user's personal information such as a resident registration number, along with the special service code of the shortened telephone number, using the user's terminal 220, and may request to generate the virtual identification information to the system of providing virtual identification information 200 of the present invention.

In this instance, the system of providing virtual identification information 200 of the present invention may check the terminal 230 of the member store where a request of a user has occurred via the special service code being inputted from the user 210, and may generate virtual identification information optimally corresponding to a feature of the verified terminal 230 of the member store.

Also, the output medium may include all kinds of media which visually or acoustically provide the user 210 with the identification code, for example, the output medium may include a display screen, an audio output device of an ARS providing an a speech associated with a product purchase, an application for a specific purpose such as a purchase application, and the like.

The system of providing virtual identification information 200 of the present invention generates to provide the virtual identification information to the user 210 using the identification code and the personal information, which are inputted from the user 210, accordingly an environment capable of providing a secure control process service may be provided to the user 210 who uses the virtual identification information.

In this instance, a format of the generated identification information is generated using an identical format to personal information provided from a user, therefore a system having been used for a server or a terminal of a member store may be used without changing the system.

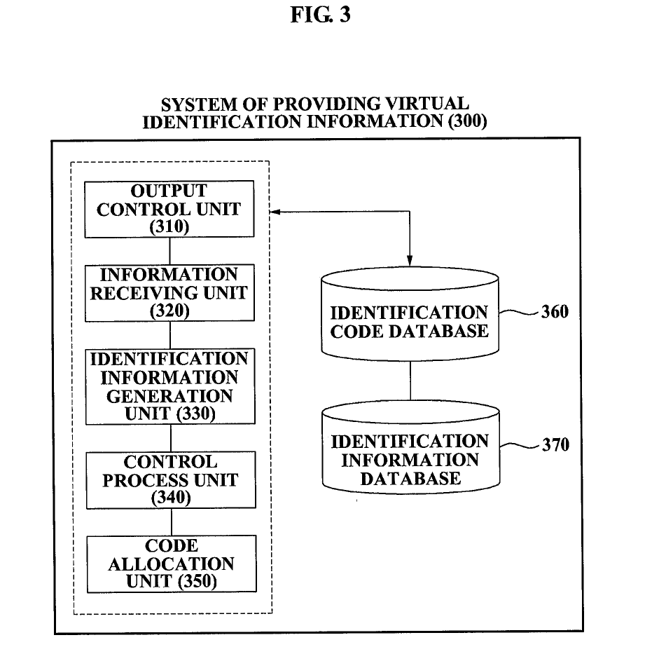

FIG. 3 is a diagram illustrating a detailed configuration of a system of providing virtual identification information 300 according to an embodiment of the present invention.

The system of providing virtual identification information 300 according to the embodiment of the present invention may include an output control unit 310, an information receiving unit 320, an identification information generation unit 330, and a control process unit 340.

The output control unit 310 exposes an output medium having an identification code to the user 210 of FIG. 2 being associated with a request of a user. As described from the FIG. 2, the identification code may be a special service code or may be a terminal identifier, the special service code being independently allocated to the terminal 230 of the member store where the request of the user is performed, and the output control unit 310 provides the output medium having the identification code being allocated to the terminal 230 of the member store.

When the output medium is a display screen connected to the terminal 230 of the member store, the output control unit 310 exposes a purchase application page being associated with a product purchase, and displays an identification code having being allocated to the terminal 230 of the member store on a predetermine area of the exposed purchase application page.

When the output medium is a speech output device associated with the member store 230, the output control unit 310 may provide an informing announcement being associated with a product purchase, via the speech output device, by including information about the identification code having being allocated to the terminal 230 of the member store in the informing announcement.

When the output medium is a web page being transmitted from the server 230 of the member store, the output control unit 310 may provide an information page associated with a product purchase, via the terminal 230 of the member store, by including the information about the identification code, having being allocated to the member store 230, in the information page.

When allocating the identification code to the member store, since the system of providing virtual identification information 300 further includes a code allocation unit 350, an environment, in which the identification code capable of selectively identifying the member store 230 being associated with the virtual identification information and is generated to be allocated to the terminal 230 of the member store, may be provided.

The code allocation unit 350 allocates the identification code to the terminal 230 of the member store in response to a request for the identification code from the terminal 230 of the member store. Specifically, the code allocation unit 350 may allocate a shortened telephone number such as 114 of the special service code to the terminal or the server 230 of the member store offline as the identification code, or may allocate a unique identification code as the terminal or the server 230 of the member store.

Also, the system of providing virtual identification information 300 may further include an identification code database 360 which stores the allocated identification code in correspondence to member store information about the member store 230. That is, the identification code database 360 correspondingly maintain the member store information, which is previously received from the member store 230, and an identification code, having been allocated to a corresponding member store, and consequently status about an identification code, having been allocated to the terminal 230 of the member store, may be accurately managed.

The information receiving unit 320 is inputted personal information of the user 210 along with the identification code from the user 210, and subsequently the user 210 identifies an identification code included in the output medium. When the user 210 is required to generate virtual identification information, the user 210 may transmit the identified identification code and the personal information to the system of providing virtual identification information 300 of the present invention via the user's terminal 220. That is, the information receiving unit 320 receives the personal information of the user 210, which is being inputted from the user 210 along with the identification code. In this instance, the personal information may be all types of information capable of identifying the user 210, such as a social identification (ID) number, a credit card number, a driver's license number, a tax payment number, a medical insurance number, or a social security number of the user.

The virtual identification generation unit 330 generates virtual identification information using the inputted identification code and personal information. Specifically, the identification information generation unit 330 generates the virtual identification information capable of securely performing a control process, which is required by the user 210, without directly exposing the personal information of the user 210.

As an example of the generating of the virtual identification information, the identification information generation unit 330 may search for member store information corresponding to the inputted identification code from the identification code database 360, and combines the retrieved member store information with the personal information to generate the virtual identification information.

As another example of the generating of the virtual identification information of operation S630, when the identification code and the personal information are inputted via the terminal 220, the identification information generation unit 330 may check an identification number of the terminal 220. A caller-ID (CID) service may be used for the verification of the identification number. The identification information generation unit 330 may generate the virtual identification information by combining the retrieved member store information, the personal information, and the verified identification number.

As an example, the identification information generation unit 330 may prepare a plurality of virtual identification information, and replace the generating of the virtual identification information with selecting predetermined single virtual identification information from the prepared plurality of virtual identification information when the generating of the virtual identification information is requested, i.e. when the personal information is inputted.

As still another example, the identification information generation unit 330 may generate the virtual identification information by considering the control process required by the user 210 and the member store information with respect to the terminal 230 of the member store, based on predetermined identification number generation rules. In this instance, the identification information generation unit 330 may generate predetermine virtual identification information using a random number generation method such as a predetermined Hash code generation scheme, and a serial scheme according to an issuing time.

The system of providing virtual identification information 300 according to the embodiment of the present invention may further include an identification information database 370 which stores the generated virtual identification information in correspondence to member store information associated with the generating of the virtual identification information. That is, the identification information database 370 maintains information to verify the provided virtual identification information when the provided virtual identification information is used by the user 210, which will be described later in the specification.

In the present specification, descriptions are limited to a case that the member store information corresponds to the generated virtual identification information to be stored in the identification information database 370, however other information such as the personal information of the user 210 and the identification number of the terminal 220 may correspond to the generated virtual identification information to be stored in the identification information database 370. In this instance, an environment in which more accurate verification is performed may be provided.

The control process unit 340 performs a control process which corresponds to the request of the user 210 as a result that the transmitted virtual identification information is inputted to the exposed output medium by the user.

That is, the control process unit 340 securely performs the control process using the virtual identification information without using the personal information of the user 210 as a result that the provided virtual identification information is inputted to the exposed output medium by the user 210.

As an example, in a purchase application page on a display screen of the output medium, with respect to the user 210 who has inputted the provided virtual identification information, the control process unit 340 may perform a purchase process without directly exposing the personal information of the user 210.

As another example, in response to the informing announcement of the ARS of the output medium, with respect to the user who has inputted the provided virtual identification information, the control process unit 340 may perform a predetermined operation associated with the purchase process by inputting the virtual identification information which is generated by transforming the personal information.

As described above, the control process may include various processes online and offline, such as a member joining process for a specific service server, and an e-commerce process for the processes online, and a product purchase process, a card member joining process, and a predetermined contract conclusion process for the processes offline.

The control process unit 340, in order to check whether the virtual identification information inputted by the user 210 is legitimate, refers to the identification information database 370, determines whether to verify the virtual identification information, and selectively performs the control process as a result of the determination. Namely, the control process unit 340 performs verification with respect to virtual identification information which is inputted to the terminal 230 of the member store. As an example of the verification, the control process unit 340 may perform the verification by determining whether member store information of the member store 230 associated with the output medium, where the virtual identification information is inputted, corresponds to member store information in the identification information database 370. The verification of the control process unit 340 may be performed using various devices such as a predetermined interface, an SMS, an ARS, a web service, and a socket, which are capable of connecting to the identification information database 370.

A result of the verification is transmitted from the control process unit 340 to the member store 230, the member store 230 selectively performs the control process as the result of the verification, and subsequently the control process may be normally performed with respect to the user 210 who has inputted legitimate virtual identification information.

In the present specification, it is described that the verification with respect to the virtual identification information is performed in the control process unit 340 of the system of providing virtual identification information 300, however the verification may be entrusted to external independent devices such as a verification read system, and the present invention may be configured to receive a result of the verification from the external independent devices.

The control process unit 340 maintains the virtual identification information after performing the control process with respect to the member store 230 where the request of the user is performed. Namely, the control process unit 340 may prevent damages due to an unlawful distribution of virtual identification information since specific virtual identification information which is provided to the user 210 is not used for another member store or for a request of another user. As an example, since the control process unit 340 manages virtual identification information, having been inputted from the terminal 230 of the member store, in connection to member store information in the identification information database 370, corresponding virtual identification information may not be verified when another user inputs virtual identification information from the another member store.

Thus, according to the present invention, an environment which can securely perform various control processes required by the user 210 using virtual identification information, the virtual identification information being generated by transforming personal information of the user 210, may be provided without directly exposing personal information of the user 210.

Also, according to the present invention, damages of easily stealing personal information may be reduced since virtual identification information is inputted instead of real personal information, which is inputted when identifying a personal identification online.

Also, according to the present invention, a control process may be securely performed using virtual identification information offline, including online, since the virtual identification information is generated using an identification code, which is allocated to a member store, a terminal of the member store, a server of the member store, or a service of the member store offline, and the generated virtual identification code is provided to a user.

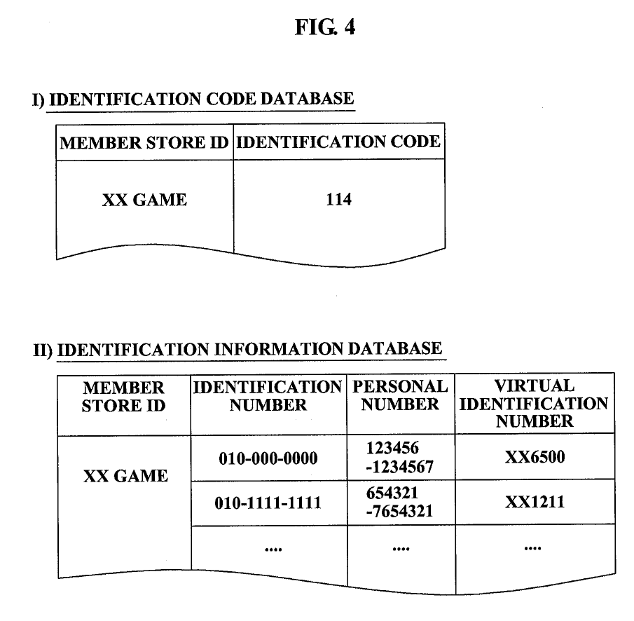

FIG. 4 is a diagram illustrating an example of an identification code database 360 of FIG. 3 and the identification information database 370 of FIG. 3 according to the present invention.

The identification code database 360 is illustrated in part i) of FIG. 4.

As described above, the identification code database 360 stores member store information in correspondence to the identification code, having been allocated to the member store 230.

When a request for an identification code is received from the member store 230 having member store information of a member store ID XX Game, the system of providing virtual identification information 300 may allocate an identification code 114 to the member store ID XX Game by considering a business type of the member store 230.

It is illustrated in part i) of FIG. 4 that the allocated identification code 114 is stored in correspondence to the member store ID XX Game.

An example of the identification information database 270 is illustrated in part ii) of FIG. 4.

The user 210 who requires to generate virtual identification information may transmit the identification code 114 and personal information ‘123456-1234567’ to the system of providing virtual identification information 300, via the terminal 220 of the user 210.

In this instance, the system of providing virtual identification information 300 searches the identification code database 360 using the inputted identification code 114 to identify the member store ID XX Game, and subsequently may verify an identification number ‘010-000-0000’ of the terminal 210 via a CID scheme.

The system of providing virtual identification information 300 combines the verified identification number ‘010-000-0000’, the inputted personal information ‘123456-1234567’, and the member store ID XX Game via a predetermined virtual identification information generation scheme to generate predetermined virtual identification information ‘234567-8901234’.

The identification information database 360 stores the identification number ‘010-000-0000’, the inputted personal information ‘123456-1234567’, and the generated predetermined virtual identification information ‘234567-8901234’ in correspondence to the identified member store ID XX Game, as illustrated in part ii) of FIG. 4, and prepares for a subsequent verification of virtual identification information.

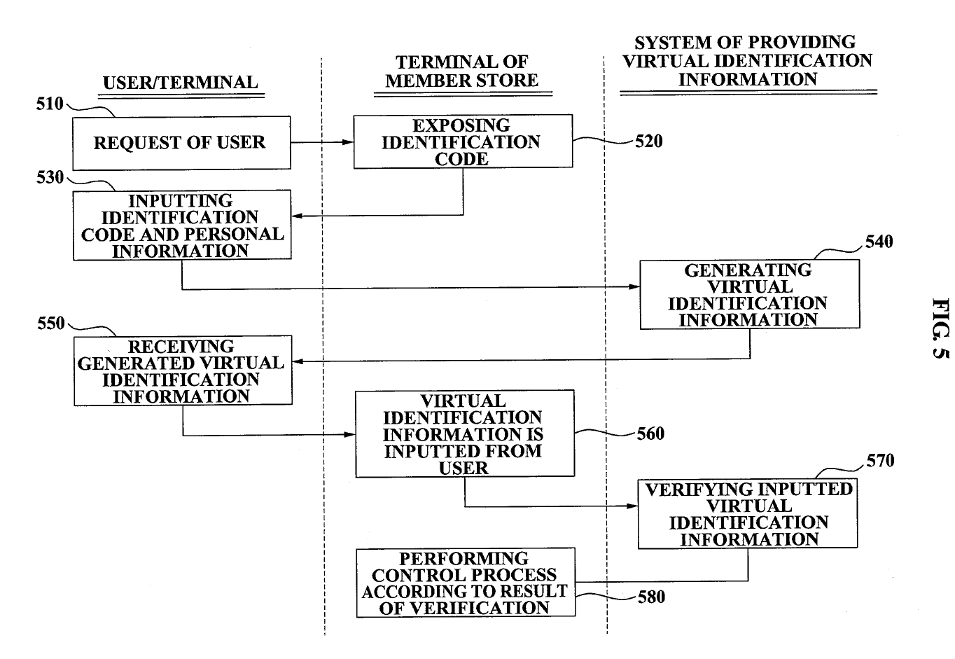

FIG. 5 is a diagram illustrating an example of performing a control process required by a user using virtual identification information of the present invention.

Initially, it is assumed that a request of a user occurs in a member store offline.

When the user 210 of FIG. 2 requests for a product purchase contract with respect to a product of the member store offline in operation 510, and an owner of the member store offline exposes an identification code to the user 210 via an output medium such as a display screen, a web page, or a printed application in operation 520, the output medium being connected via the member store, the terminal of the member store, or the server of the member store 230 of FIG. 2. In this instance, the identification code may be a special service code which is previously allocated to the member store.

The user 210 inputs the exposed identification code and personal information of the user 210 to the terminal 220 of the user 210 in operation 530, and the system of providing virtual identification information 300 receives the exposed identification code and the personal information of the user 210, having been inputted to the terminal 220 of the user 210 via a communication network, to generate virtual identification information in operation 540. In this instance, an information transmission media between the terminal 220 of the user 210 and the system of providing virtual identification information 300 may be an SMS, an SMS MO, a Web, WINC, a callback SMS, a WAP, a WAP PUSH, an ARS, and the like, and the system of providing virtual identification information 300 checks an identification number of the terminal 220 of the user 210 using a CID scheme, searches for member store information which corresponds to the identification code, combines the member store information, the identification number, and the personal information to generate the virtual identification information, the virtual identification information being generated by transforming the personal information. The generated virtual identification information may be disposable information which is valid with respect to the request of the user 210 or the member store 230.

The user 210 receives the generated virtual identification information from the system of providing virtual identification information 300 in operation 550. The generated virtual identification information may be received in a format such as an SMS MO, a Web, a WINC, a callback SMS, a WAP, a WAP PUSH, and an ARS.

The member store 230 is inputted the virtual identification information from the user 210, having received the virtual identification information, via the output medium, and subsequently the member store 230 requests to check the inputted virtual identification information being inputted to the system of providing virtual identification information 300 in operation 560. When the output media is a written letter, the verification may be manually requested using communication devices such as a wired telephone, a mobile phone, and a PC, which may be used in the member store, the terminal of the member store, or the server of the member store 230.

The system of providing virtual identification information 300 determines whether virtual identification information is legitimate according to the requested verification, and verifies the virtual identification information when the virtual identification information being inputted by the user 210 is normally generated with respect to the member store 230 in operation 570.

The member store 230 normally performs a control process requested by the user 210, i.e. the product purchase contract, according to a result of the verification, which is received from the system of providing virtual identification information 300, in operation 580.

Accordingly, the user 210 may be provided with a required control service using the virtual identification information without directly exposing personal information of the user 210. Also, the system of providing virtual identification information 300 may provide an environment capable of securely performing a control process which optimally corresponds to a request of the user 210 occurring offline without directly exposing personal information.

As another example, it is assumed that a request for a virtual identification information occurs via an ARS.

When the user 210 requests an owner of a member store for a purchase contract for a product of the member store in operation 510, the owner of the member store exposes an identification code to the user 210 via an output media such as a display screen, a web page, or a printed application in operation 520. In this instance, the identification code may be a special service code which is previously allocated to the terminal 230 of the member store.

In operation 530, the user 210 makes a call to an ARS number which corresponds to a virtual identification information issuing service via the terminal 220 of the user 210, or makes a call to an ARS special service code which is allocated to a corresponding member store, and inputs the exposed identification code and personal information of the user 210 according to an ARS informing announcement. In operation 540, the system of providing virtual identification information 300 of the present invention is inputted the identification code and the personal information of the user 210, having been inputted to the terminal 220 of the user 210, to generate virtual identification information. In this instance, the system of providing virtual identification information 300 checks an identification number of the terminal 220 of the user 210 using the CID scheme, searches for member store information which corresponds to the identification code, generates virtual identification information, which is generated by transforming the personal information, and stores the generated virtual identification information. The generated virtual identification information may be disposable information which is valid with respect to the request of the user 210 or the member store 230.

In operation 550, the user 210 receives the generated virtual identification information from the system of providing virtual identification information 300. The generated virtual identification information may be received in a format of a speech message via an SMS to the terminal 220 or the ARS.

In operation 560, the member store 230 is inputted from the user 210, having received the virtual identification information, via the output medium, and subsequently the system of providing virtual identification information 300 requests to verify with respect to the inputted virtual identification information. When the output media is a written letter, devices of the member store virtual identification information such as a wired telephone, a mobile phone, and a PC may be additionally used for the verification.

In operation 570, the system of providing virtual identification information 300 determines whether virtual identification information is legitimate according to the requested verification, and verifies the virtual identification information when the virtual identification information being inputted by the user 210 is normally generated with respect to a corresponding member store.

In operation 580, the member store 230 normally performs a control process requested by the user 210, i.e. the product purchase contract, according to a result of the verification, which is received from the system of providing virtual identification information 300.

Accordingly, the user 210 may be provided a required control service using the virtual identification information without directly exposing personal information of the user 210. Also, the system of providing virtual identification information 300 may provide an environment capable of securely performing a control process which optimally corresponds to a request of a user occurring in the format of the ARS without directly exposing personal information.

As another example, it is assumed that when a request of a user occurs online.

The user 210 joins a service of a member store via a server of the member store in operation 510, and an owner of the member store exposes an identification code to the user 210 via an output medium such as a web page or a WAP page in operation 520, the output medium being connected via the terminal of the member store, or the server of the member store 230. In this instance, the identification code may be a special service code which is previously allocated to the terminal 230 the member store.

The user 210 inputs the exposed identification code and personal information of the user 210 to the terminal 220 of the user 210 in operation 530, and the system of providing virtual identification information 300 receives the exposed identification code and the personal information of the user 210, having been inputted to the terminal 220 of the user 210 via a communication network, to generate virtual identification information in operation 540. In this instance, an information transmission media between the terminal 220 of the user 210 and the system of providing virtual identification information 300 may be an SMS, an SMS MO, a Web, WINC, a callback SMS, a WAP, a WAP PUSH, an ARS, and the like, and the system of providing virtual identification information 300 checks an identification number of the terminal 220 of the user 210 using a CID scheme, searches for member store information which corresponds to the identification code, combines the member store information, the identification number, and the personal information to generate the virtual identification information, the virtual identification information being generated by transforming the personal information. The generated virtual identification information may be disposable information which is valid with respect to the request of the user 210 or the member store 230.

In operation 550, the user 210 receives the generated virtual identification information from the system of providing virtual identification information 300. The generated virtual identification information may be received in a format such as an SMS MO, a Web, a WINC, a callback SMS, a WAP, a WAP PUSH, and an ARS.

In operation 560, the member store 230 is inputted from the user 210, having received the virtual identification information, via the output medium such as a web page or a WAP page, subsequently the member store 230 requests to verify the inputted virtual identification information being inputted to the system of providing virtual identification information 300.

In operation 570, the system of providing virtual identification information 300 determines whether the inputted virtual identification information is legitimate according to the requested verification, and verifies the virtual identification information when the virtual identification information being inputted by the user 210 is normally generated with respect to the member store 230.

In operation 580, the member store 230 performs a control process requested by the user 210, i.e. the product purchase contract, according to a result of the verification, which is received from the system of providing virtual identification information 300.

Accordingly, the user 210 may join a required web site using the virtual identification information without directly exposing personal information of the user 210.

Hereinafter, flows of operations of a system of providing virtual identification information according to an embodiment of the present invention will be described.

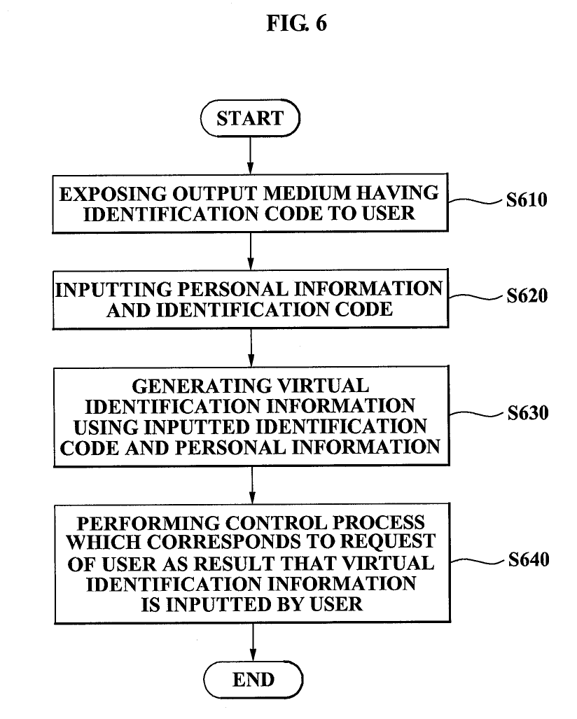

FIG. 6 is a flowchart illustrating a method of providing virtual identification information according to an embodiment of the present invention.

The method of providing virtual identification information according to the embodiment of the present invention may be performed by the above described system of providing virtual identification information 300.

The system of providing virtual identification information 300 exposes an output medium having an identification code to the user 210 being associated with a request of the user 210 in operation S610. In this instance, the identification code may be a special service code which is allocated to the member store 230 where the request of the user is performed, or may be a terminal identifier, and the system of providing virtual identification information 300 provides the output medium having the identification code, which is allocated to the member store 230.

When the output medium is a display screen connected with the terminal 230 of the member store, the system of providing virtual identification information 300 exposes a purchase application page being associated with a product purchase on the display screen, and displays an identification code having being allocated to the terminal 230 of the member store on a predetermined area of the exposed purchase application page.

When the output medium is a speech output device associated with the member store 230, the system of providing virtual identification information 300 provides an informing announcement being associated with a product purchase, via the speech output device, and provides information about the identification code, having been allocated to the member store.

In operation S610, the system of providing virtual identification information 300 may further include operations of generating an identification code which is capable of selectively identifying the terminal 230 of the member store being associated with the providing of virtual identification information of the present invention, and of allocating the generated identification code to the terminal 230 of the member store.

That is, the system of providing virtual identification information 300 may allocate an identification code to the member store 230 in response to a request for the identification code from the terminal 230 of the member store, where a request of a user is performed. As an example, the system of providing virtual identification information 300 may allocate a shortened telephone number 114 of the special service code to the terminal 230 of the member store in an offline member store, or allocated a unique terminal identifier as the identification code.

In operation S610, the system of providing virtual identification information 300 stores the allocated identification code in the identification code database 360 of FIG. 3 in correspondence to member store information about the member store 230. That is, the system of providing virtual identification information 300 correspondingly maintains the member store information, which is previously received from the member store 230, to an identification code being allocated to a corresponding member store, and consequently manages accurately manage status about an identification code being allocated to the terminal 230 of the member store.

In operation S620, the system of providing virtual identification information 300 is inputted with personal information of the user 210 along with the identification code from the user 210, and subsequently the user 210 identifies an identification code included in the output medium. When the user 210 requires generating of virtual identification information, the user 210 may transmit the identified identification code and the personal information to the system of providing virtual identification information 300 of the present invention via the user's terminal 220. In operation S620, the personal information of the user 210, which is being inputted from the user 210 along with the identification code, is received. In this instance, the personal information may be any type of information capable of identifying the user 210, such as a social identification (ID) number, a credit card number, a driver's license number, a tax payment number, a medical insurance number, or a social security number of the user.

In operation S630, the system of providing virtual identification information 300 generates virtual identification information using the inputted identification code and personal information. Specifically, in operation S630, the system of providing virtual identification information 300 generates the virtual identification information capable of securely performing a control process, which is required by the user 210, without directly exposing the personal information of the user 210.

As an example of the generating of the virtual identification information of operation S630, the system of providing virtual identification information 300 may search for member store information corresponding to the inputted identification code from the identification code database 360, and combine the retrieved member store information with the personal information to generate the virtual identification information.

As another example of the generating of the virtual identification information, when the identification code and the personal information are inputted via the terminal 220, the system of providing virtual identification information 300 may check an identification number of the terminal 220. A caller-ID (CID) service may be used for the verification of the identification number. The system of providing virtual identification information 300 may generate the virtual identification information by combining the retrieved member store information, the personal information, and the verified identification number.

The system of providing virtual identification information 300 in operation S630 may correspond to the generated virtual identification information to the member store information associated with the generating of the virtual identification information to maintain the corresponded result in the identification information database 370. That is, the system of providing virtual identification information 300, when the virtual identification information is used by the user 210 later, maintains information to verify when the user 210 finally uses the virtual identification information.

In operation S640, the system of providing virtual identification information 300 performs a control process which corresponds to a request of the user 210 as a result that transmitted virtual identification information is inputted to the exposed output medium by the user 210.

Specifically, the system of providing virtual identification information 300 may perform a product purchase process with respect to the user 210 who uses the provided virtual identification information without directly exposing personal information of the user 210.

As another example, the system of providing virtual identification information 300 may perform a product purchase process with respect to the user 210 who inputs the virtual identification information in response to an ARS informing announcement of a speech output device of the output medium, by inputting virtual identification information which is generated by transforming personal information.

As described above, the control process may include various processes online and offline, such as a member joining process for a specific service server, and an e-commerce process for processes online, and a product purchase process, a card member joining process, and a predetermined contract conclusion process for processes offline.

Specifically, in operation S640, the system of providing virtual identification information 300, in order to check whether the virtual identification information inputted by the user 210 is legitimate, refers to the identification information database 370, determines whether to verify the virtual identification information, and selectively performs the control process as a result of the determination. Namely, the system of providing virtual identification information 300 performs verification with respect to virtual identification information which is inputted to the terminal 230 of the member store. As an example of the verification, the system of providing virtual identification information 300 may perform the verification by determining whether member store information of the terminal 230 of the member store associated with the output medium, where the virtual identification information is inputted, corresponds to member store information in the virtual identification information database 370.

A result of the verification is transmitted from the system of providing virtual identification information 300 to the terminal 230 of the member store, the terminal 230 of the member store selectively performs the control process as the result of the verification, and subsequently the control process may be normally performed with respect to the user 210 who has inputted legitimate virtual identification information.

Also, in operation S640, the system of providing virtual identification information 300 maintains the virtual identification information with respect to the terminal 230 of the member store, where the request of the user 210 is performed, after performing the control process. Accordingly, the system of providing virtual identification information 300 may prevent damages due to an unlawful distribution of the virtual identification information since the virtual identification information is not used for a terminal of another member store or a request of another user. As an example, since the system of providing virtual identification information 300 manages the virtual identification information, having been inputted from the terminal 230 of the member store, in connection to member store information in the identification information database 370, corresponding virtual identification information may not be verified when another user inputs virtual identification information from the other member store.

Thus, according to the present invention, an environment which can securely perform various control processes required by the user 210 using virtual identification information, the virtual identification information being generated by transforming personal information of the user 210, may be provided without directly exposing personal information of the user 210.

Also, according to the present invention, damages by easily stolen personal information may be reduced since virtual identification information is inputted instead of real personal information, which is inputted when identifying a personal identification online.

Also, according to the present invention, a control process may be securely performed using virtual identification information offline, including online, since the virtual identification information is generated using an identification code, which is allocated to a member store, a terminal of the member store, a server of the member store, or a service of the member store offline, and the generated virtual identification code is provided to a user.

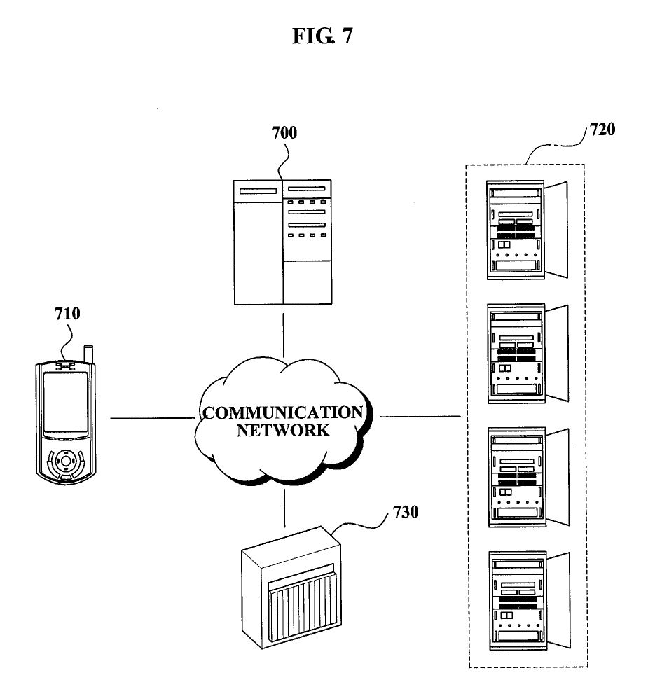

FIG. 7 is a diagram illustrating a network connection of a system of providing virtual identification information 700 according to another embodiment of the present invention.

According to an embodiment of the present invention, a terminal 710 is inputted personal information, a joining target site name, and verification information from a user, and transmits a message to a receiving number being associated with the system of providing virtual identification information 700. In this instance, the receiving number is used for an SMS MO service associated with the system of providing virtual identification information 700, and is a type of a telephone number of a mobile communication terminal to transmit the message to the system of providing virtual identification information 700. Also, the personal information is a real resident registration number of an owner or a user of the terminal 710, the joining target site name is a site name where the user of the terminal 710 requires to join, and the verification information includes a credit card number, a bank account number, personal identity of the user of the terminal 710 to verify a user.

According to the another embodiment of the present invention, the terminal 710 connects to a WAP using a WINC to select a joining target site, and inputs the personal information and the verification information.

Also, according to the other embodiment of the present invention, the terminal 710 connects to a joining target server of the joining target site to request virtual identification information, receives a message including a callback URL from the joining target server, and connects to a wireless Internet using the callback URL to input the personal information and the verification information.

The system of providing virtual identification information 700 receives the message from the terminal 710, separates the personal information, the joining target site name, the verification information, and a terminal identification number of the terminal 710 from the message. The terminal identification number may be a telephone number of the terminal 710 or a product serial number of the terminal 710. The system of providing virtual identification information 700 requests a user verification system 720 to verify a user, the user verification system 720 may be one of a server of a mobile communication company, a server of a credit card company, a server of a back, and a server for verifying personal identity, and servers may differ according to the verification information.

According to an embodiment of the present invention, when the user verification system 720 is a server of a mobile communication company, the system of providing virtual identification information 700 transmits the personal information and the terminal identification number to the server of the mobile communication company, and requests to verify a user. The server of the mobile communication company performs the verification with respect to the user by referring to a mobile communication customer database, and informs a result of the verification to the system of providing virtual identification information 700.

According to another embodiment of the present invention, when verification information is a credit card number, an expiry date, and a password, the system of providing virtual identification information 700 requests the server of the credit card company to verify a user by using a server of a credit card company as the user verification system 720. The server of the credit card company performs the verification with respect to the user by referring to a credit card client database, and informs a result of the verification to the system of providing virtual identification information 700.

According to still another embodiment of the present invention, when the verification information is a bank account number and a password, the system of providing virtual identification information 700 requests to verify a user by using a server of a bank as the user verification system 720. The server of the bank performs the verification with respect to the user using a bank client database, and informs a result of the verification to the system of providing virtual identification information 700.

According to yet another embodiment of the present invention, when the verification information is a name of a user, the system of providing virtual identification information 700 requests to verify the user using personal identity verification server as the user verification system 720. The personal identity verification server performs the verification with respect to the user by referring to a personal information database, and informs a result of the verification to the system of providing virtual identification information 700.

The system of providing virtual identification information 700 receives the result of the verification from the user verification system 720, and generates virtual identification information using the personal information, the joining target site name, and the terminal identification number when the user is verified. The virtual identification information may be generated by entirely or partially combining the personal information, the joining target site name, and the terminal identification number. The system of providing virtual identification information 700 transmits the generated virtual identification information to the terminal 710. In this instance, the system of providing virtual identification information 700 may record the virtual identification information in a verification details database in association with a number of the terminal 710.

The terminal 710 receives the virtual identification information, and the user connects to a joining target server 730 of the joining target site name to input the virtual identification information.

The joining target server 730, i.e. the joining target site, receives the virtual identification information, checks whether the virtual identification information is valid according to a predetermined rule of detecting virtual identification information, and requests the system of providing virtual identification information 700 to verify the virtual identification information.

The system of providing virtual identification information 700 receives the virtual identification information from the joining target server 730, and verifies the virtual identification information by referring to the verification details database. The system of providing virtual identification information 700 transmits the result of the verification to the joining target server 730.

The joining target server 730 receives the result of the verification from the system of providing virtual identification information 700, and approves of the joining of the user of the terminal 710 when the user is verified.

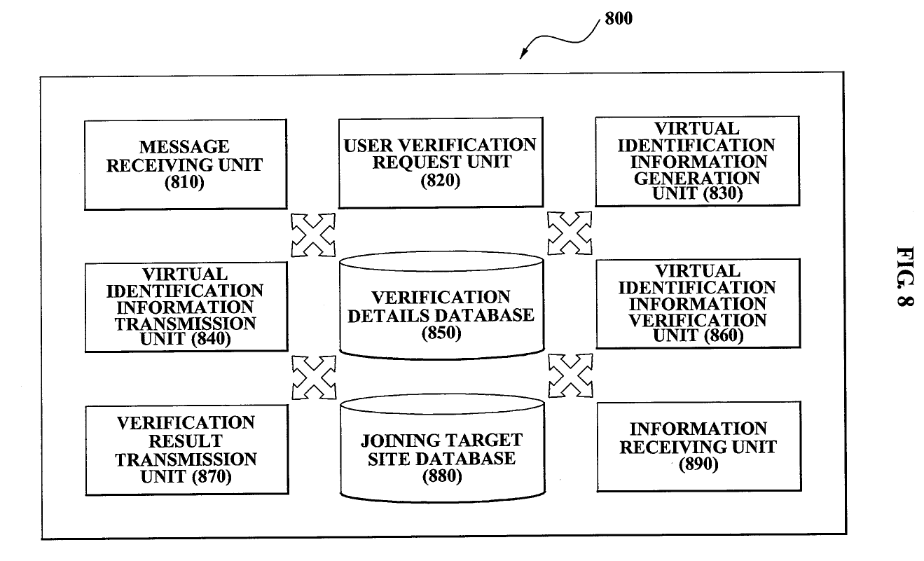

FIG. 8 is a block diagram illustrating a configuration of a system of providing virtual identification information 800 according to an embodiment of the present invention.

The system of providing virtual identification information 800 according to the embodiment of the present invention includes a message receiving unit 810 receiving a message including personal information, a joining target site name, and verification information from the terminal 710 of FIG. 7, a user verification request unit 820 extracting a terminal identification number of the terminal 710 of FIG. 7 and verification information from the message, and requesting the user verification system 720 of FIG. 7 to verify a user, a virtual identification information generation unit 830 generating virtual identification information using the terminal identification number, the personal information, and the joining target site name when the user is verified, and a virtual identification information transmission unit 840 transmitting the generated virtual identification information.

According to another embodiment of the present invention, the system of providing virtual identification information 800 includes an information receiving unit 890 being selected to join a target site from the terminal 710, having been connected to a WAP using a mobile address WINC, and receiving personal information and verification information, and the user verification request unit 820 transmits at least one of the inputted personal information, terminal identification number, and verification information to the user verification system 720 to request verification with respect to a user.

According to still another embodiment of the present invention, the information receiving unit 890 is inputted with personal information and verification information from the terminal, having been connected to a wireless Internet using a callback URL of a message, the message being received from a joining target server of a joining target site.

According to an embodiment of the present invention, the user verification request unit 820 requests the user verification system 720 to verify the user, and the user verification system 720 may be one of a server of a mobile communication company, a server of a credit card company, a server of a bank, and a server of verifying personal identity. When the user verification system 720 is a server of a mobile communication company, the user verification request unit 820 transmits the personal information and the terminal identification number to the server of the mobile communication company, and requests verifying a user. When the verification information is a credit card number, an expiry date, and a password, the user verification request unit 820 transmits the credit card number, expiry date, or password to the server of the credit card company, when the verification information is a bank account number and a password, the user verification request unit 820 transmits the bank account number or the password to the server of the bank, and when the verification information is a user's name, the user verification request unit 820 transmits the user's name to a personal verification server, and subsequently may request verification with respect to the user.

According to an embodiment of the present invention, the virtual identification information generation unit 830 combines the terminal identification number, the personal information, and the joining target site name using a predetermined Hash code generation scheme, or a serial scheme according to an issuing time, and generates the virtual identification information.

Also, according to another embodiment of the present invention, the system of providing virtual identification information 800 further includes a verification details database 850 which stores the virtual identification information in association with the terminal identification number for verification with respect to the virtual identification information. The joining target server 730 receives the virtual identification information, checks whether the virtual identification information is valid according to a predetermined rule of detecting validity, and requests the system of providing virtual identification information 800 to verify the virtual identification information. The system of providing virtual identification information 800 further includes a virtual identification information verification unit 860 and a verification result transmission unit 870, the virtual identification information verification unit 860 verifying the virtual identification information, having been received from the joining target server 730, by referring to the verification details database 850, and the verification result transmission unit 870 transmitting a result of the verification with respect to the virtual identification information to the joining target server 730.

Accordingly, the user is not required to directly expose actual personal information by inputting the virtual identification information instead of actual personal information when the user joins a joining target server.

Also, according to another embodiment of the present invention, the system of providing virtual identification information 800 further includes a joining target site database 880 which stores a joining target site number in association with a joining target site name. The joining target site number is used for an SMS MO service, and the system of providing virtual identification information 800 identifies the joining target site number to check the joining target site name. Accordingly, the terminal 710 includes the personal information in the message, inputs a joining target site number of the joining target server 730 to transmit the message. The message receiving unit 810 receives the message including the personal information from the terminal 710, the user verification request unit 820 extracts a terminal identification number to request the joining target server 730 to verify a user, and the virtual identification information generation unit 830 extracts the joining target site name from the joining target site database 880 to generate virtual identification information using the terminal identification number and the personal information.

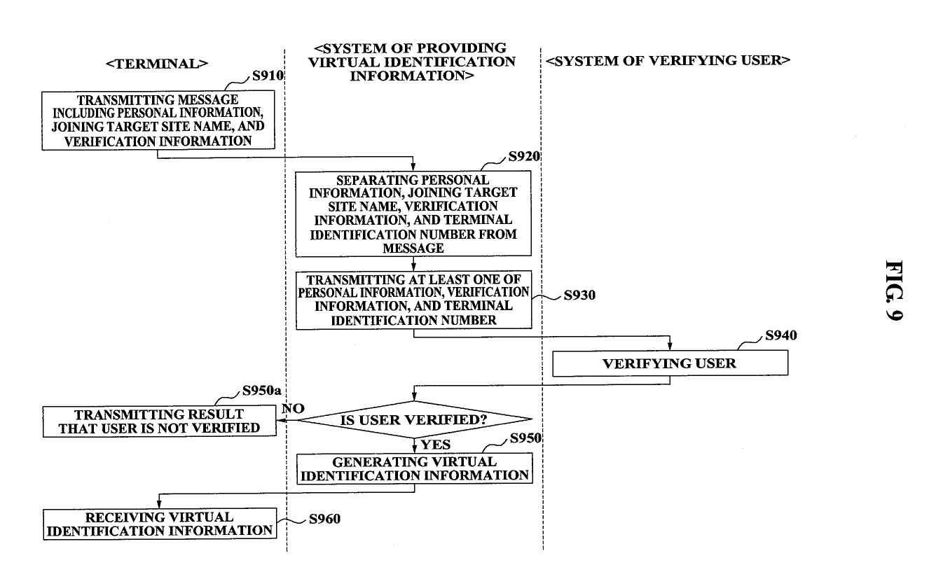

FIG. 9 is a flowchart illustrating a method of providing virtual identification information according to an embodiment of the present invention.

In operation S910, the terminal 710 transmits a message including personal information, a joining target site name, and verification information to the system of providing virtual identification information 800. The user of the terminal 710 may input virtual identification information instead of actual personal information to join a joining target site as a member, for this, is required to transmit the personal information, the joining target site name, and the verification information to the system of providing virtual identification information 800.

In this instance, a receiving number transmitting the message may be an SMS MO service number associated with the system of providing virtual identification information 800, for example, when the system of providing virtual identification information 800 is allocated ‘123-1234’, the terminal 710 inputs ‘123-1234’ as the receiving number to transmit the message, and the message is transmitted to the system of providing virtual identification information 800. Also, the verification information is to verify the user prior to generating the virtual identification information, and different information may be inputted according to the user verification system 720. As an example, the verification information may include a credit card number, a bank account number, a personal identity of the user of the terminal 710.

In operation S920, the message receiving unit 810 of the system of providing virtual identification information 800 receives a message including the personal information, the joining target site name, and the verification information. The system of providing virtual identification information 800 analyzes the message to separate the personal information, the joining target site name, and the verification information, and checks a telephone number, having transmitted the message, to find out the number of the terminal 710.

In operation S930, the user verification request unit 820 of the system of providing virtual identification information 800 transmits at least one of the personal information, the joining target site name, and the verification information to the user verification system 720 to request verification with respect to a user.

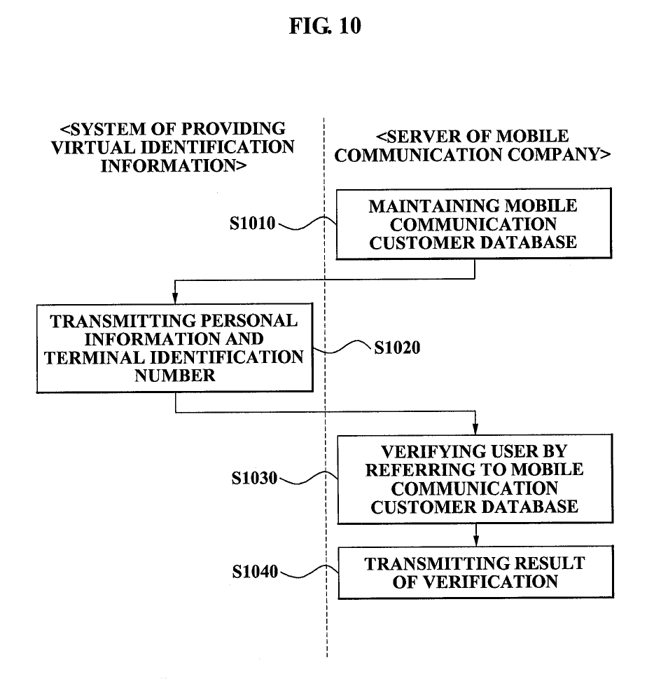

In operation S940, the user verification system 720 receives at least one of the personal information, the joining target site name, and the verification information from the system of providing virtual identification information 800 to perform verification with respect to the user. According to an embodiment of the present invention, the user verification system 720 may be one of a server of a mobile communication company, a server of a credit card company, a server of a bank, and a server for verifying personal identity. Hereinafter, descriptions will be made by referring to FIGS. 10 through 13.

FIGS. 10 through 13 are flowcharts illustrating a method of verifying a user according to an embodiment of the present invention.

FIG. 10 illustrates when the user verification system 720 is a server of a mobile communication company.

In operation S1010, the server of the mobile communication company, when the terminal 710 is registered to be used, stores to maintain a user's name, personal information, an address, and a product serial number in association with a terminal identification number, i.e. telephone number. Accordingly, verification with respect to the user may be performed when the personal information and the terminal identification number are known.

In operation S1020, the system of providing virtual identification information 800 transmits the personal information and the terminal identification number to the server of the mobile terminal to request verification with respect to a user.

In operation S1030, the server of the mobile communication company receives the personal information and the terminal identification number, and verifies the user by referring to the mobile communication customer database. The server of the mobile communication company verifies the user after determining whether mobile communication customer information which corresponds to the personal information and the terminal identification number exists in the mobile communication customer database.

In operation S1040, the server of the mobile communication company transmits a result of the verification to the system of providing virtual identification information 800.

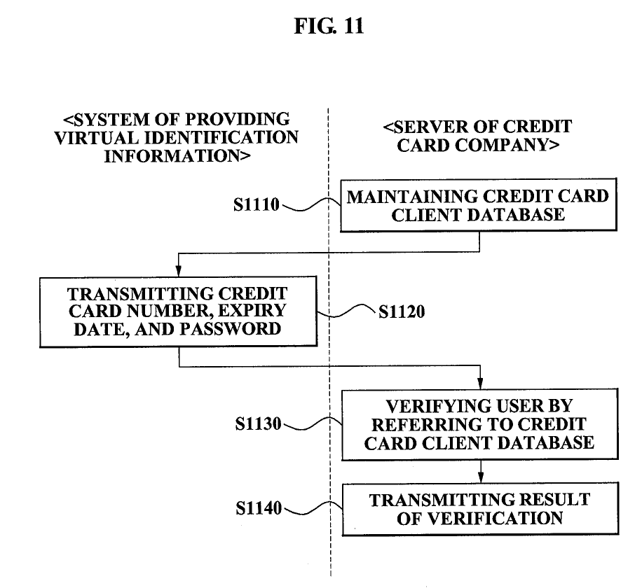

FIG. 11 illustrates when the user verification system 720 is a server of a credit card company. In this instance, the system of providing virtual identification information 800 receives the verification information of a credit card number, an expiry date, and a password from the terminal 710.

In operation S1110, the server of the credit card company stores to maintain personal information of each user in a credit card client database in association with the credit card number, the expiry date, and the password.

In operation S1120, the system of providing virtual identification information 800 transmits the credit card number, the expiry date, and the password to the server of the credit card company to request verification with respect to a user.

In operation S1130, the server of the credit card company receives the credit card number, the expiry date, and the password from the system of providing virtual identification information 800, and verifies the user after determining whether credit card client information which corresponds to the credit card number, the expiry date, and the password exists in the mobile communication customer database.

In operation S1140, the server of the credit card company transmits a result of the verification to the system of providing virtual identification information 800.

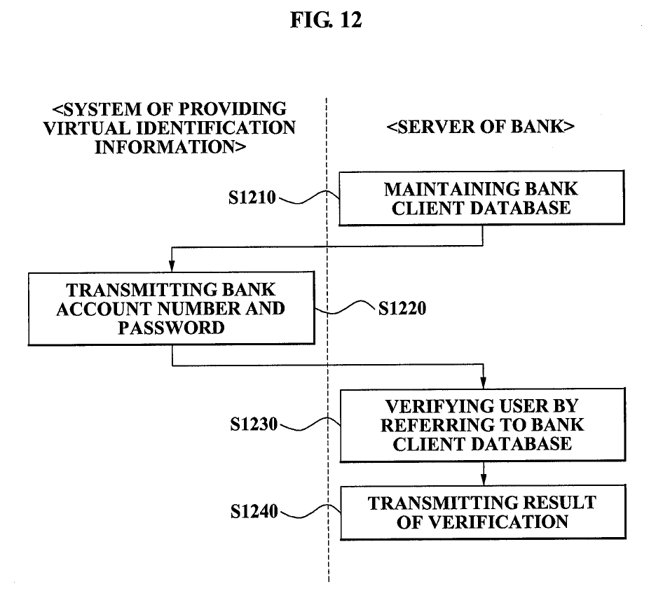

FIG. 12 illustrates when the user verification system 720 is a server of a bank. In this case, the system of providing virtual identification information 800 receives a bank account number and a password for the verification information, from the terminal 710.

In operation S1210, the server of the bank, when a bank account is registered, stores to maintain each user's personal information in a bank client database in association with each of the bank account number and password.

In operation S1220, the system of providing virtual identification information 800 transmits the bank account number and the password, having been received as verification information, to the server of the bank to request the user.

In operation S1230, the server of the bank receives the bank account number and the password, and verifies the user by referring to the bank client database.

In operation S1240, the server of the bank transmits a result of the verification to the system of providing virtual identification information 800.

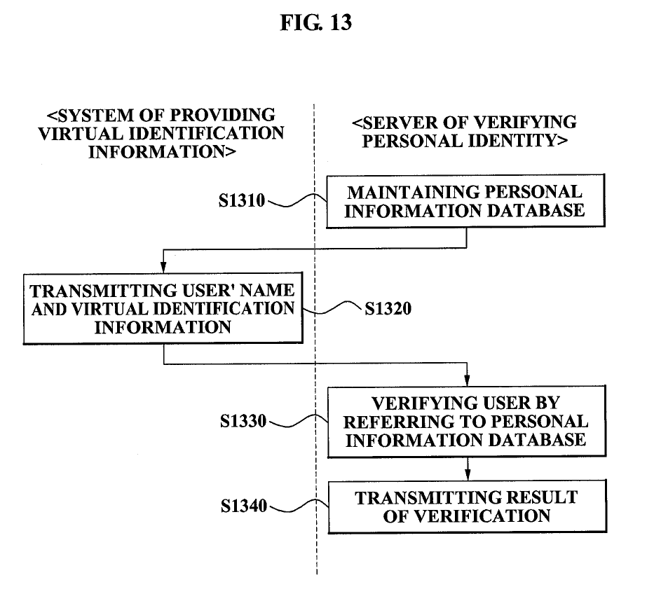

FIG. 13 illustrates when the user verification system 720 is a server of verifying a personal identification. In this instance, the system of providing virtual identification information 800 receives a user's name for the verification information, from the terminal 710.

In operation S1310, the server of verifying personal identity is to manage resident management regarding births and deaths, and stores to maintain each user's personal information, such as a user's name, a resident registration number, and an address, in a personal information database.

In operation S1320, the system of providing virtual identification information 800 transmit the user's name, the resident registration number, and the address, having been received as the verification information, to the server of verifying personal identity, and requests verification with respect to a user.

In operation S1330, the server of verifying personal identity receives the user's name, the resident registration number, and the address, and verifies the user by referring to the personal information database.

In operation S1340, the server of verifying personal identity transmits a result of the verification to the system of providing virtual identification information 800.

Referring back to FIG. 9, in operation S950, the virtual identification information generation unit 830 of the system of providing virtual identification information 800 receives the result of the verification from the user verification system 720, when the user is verified, and generates the virtual identification information using the terminal identification number, the personal information, and the joining target site name. The virtual identification information generation unit 830 entirely or partially combines the number of the terminal 710, the personal information, the joining target site name, and a predetermined number, to generate thirteen digits of the virtual identification information to be similar as an actual resident registration number, which is configured in thirteen digits.

According to an embodiment of the present invention, the virtual identification information generation unit 830 may generate the virtual identification information using a predetermined Hash code generation scheme, or a serial scheme according to an issuing time, and generates the virtual identification information. The issuing time may be a time when the message is received, and the virtual identification information generation unit 830 may generate the virtual identification information using a date, a time, a minute, and a second of the time when the message is received. The virtual identification information transmission unit 840 of the system of providing virtual identification information 800 transmits the generated virtual identification information to the terminal 710.

However, when the user is not verified, in operation S950a, the system of providing virtual identification information 800 informs that the user is not verified.

In operation S960, the terminal 710 receives the virtual identification information from the system of providing virtual identification information 800, and the user inputs the virtual identification information to the joining target server 730, subsequently the user is joined as a member.

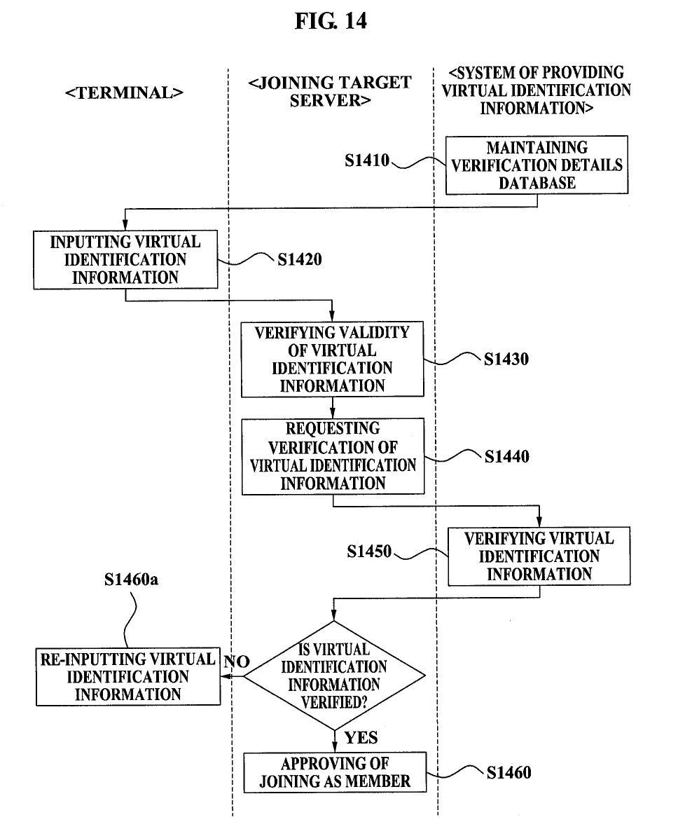

FIG. 14 is a flowchart illustrating a method of verifying virtual identification information according to an embodiment of the present invention.

In operation S1410, the system of providing virtual identification information 800 stores the virtual identification information in the verification details database 850, in association with the telephone number of the terminal 710.

In operation S1420, the terminal 710 inputs the received virtual identification information to the joining target server 730.

In operation S1430, the joining target server 730 receives the virtual identification information from the terminal 710, and checks whether the virtual identification information is valid according to a predetermined rule of detecting virtual identification information. As an example, the joining target server 730 applies the predetermined rule of detecting virtual identification information to the virtual identification information according to values and locations of each figure of the virtual identification information, checks whether a calculated value corresponds to a last thirteenth figure, and subsequently may check whether the virtual identification information is valid. Specifically, the joining target server 730 respectively multiplies a first figure by 1, a second figure by 2, . . . and a twelfth figure by 12, adds up the multiplied values, divides the added value by 10, and checks whether the divided value corresponds to the thirteenth figure.

In operation S1440, the joining target server 730 requests the system of providing virtual identification information 800 to verify the virtual identification information when the virtual identification information is valid. The joining target server 730 determines the virtual identification information is valid when a result of the determination is identical to the thirteenth figure. In this instance, the joining target server 730 transmits the terminal identification number of the terminal 710, having been inputted with the personal information and the virtual identification information, to the system of providing virtual identification information 800, and requests the system of providing virtual identification information 800 to verify the virtual identification information.

In operation S1450, the virtual identification information verification unit 860 of the system of providing virtual identification information 800 receives the verification request with respect to the virtual identification information, and verifies the virtual identification information by referring to the verification details database 850. The virtual identification information verification unit 860 determines whether information which corresponds to the virtual identification information and the terminal identification number exists in the verification details database 850, subsequently the virtual identification information may be verified. The verification result transmission unit 870 of the system of providing virtual identification information 800 transmits the verification result of the virtual identification information to the joining target server 730.

In operation S1460, the joining target server 730 receives the verification result from the system of providing virtual identification information 800, and approves the user of joining as a member when the virtual identification information is verified. When the virtual identification information is not verified, the joining target server 730 requests the user to re-input the virtual identification information in operation S1460a.

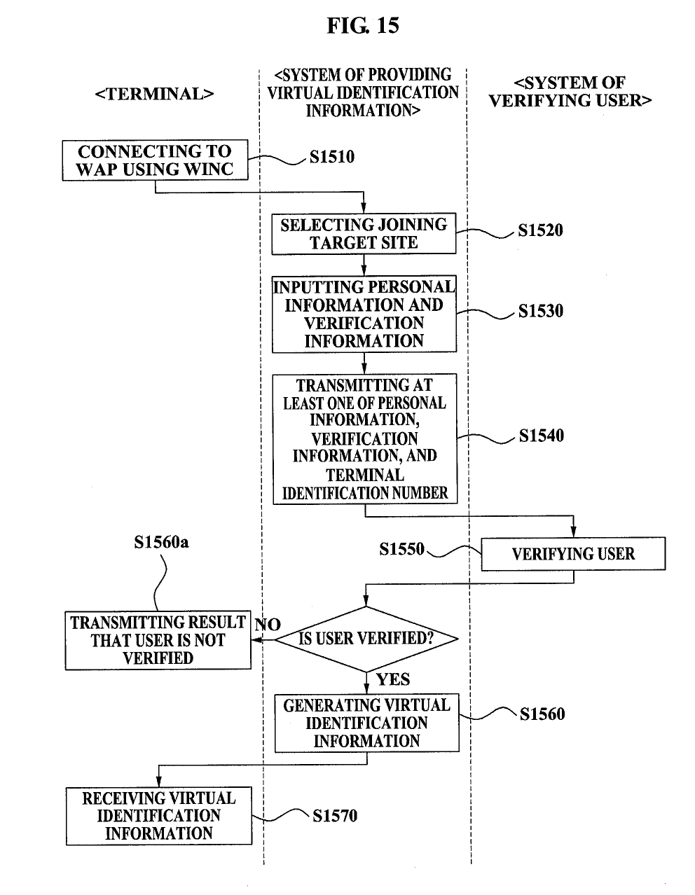

FIGS. 15 through 17 are flowcharts illustrating a method of providing virtual identification information according to another embodiment of the present invention.

As illustrated in FIG. 15, unlike FIG. 9, FIG. 15 is a flowchart illustrating connecting to a WAP using a mobile address WINC, and inputting personal information, a joining target site, and verification information.

In operation S1510, the terminal 710 connects to the WAP using the mobile address WINC. The mobile address WINC is a type of a service which uses numbers instead of a complex URL when connecting to a wireless Internet in mobile communication devices. Specifically, when the terminal 710 inputs ‘1234’, and clicks a wireless Internet button, the terminal 710 is directly connected to a homepage at http://www.wisegram.com. In the present invention, the terminal 710 is directly connected to a homepage of the system of providing virtual identification information 800 by inputting a mobile address 3456, the mobile address 3456 directly connecting the terminal 710 to the homage of the system of providing virtual identification information 800.

In operations S1520 and S1530, the information receiving unit 890 of the system of providing virtual identification information 800 is selected a joining target site from the terminal 710, and receives personal information and verification information. The information receiving unit 890 provides a user interface page where the joining target site, the personal information, and the verification information may be inputted, and user interface page may include an input field with respect to the joining target site, the personal information, and the verification information.

Since descriptions regarding operations S1540 through S1570 are similar to descriptions regarding operations S930 through S960, the descriptions regarding operations S1540 through S1570 will be omitted.

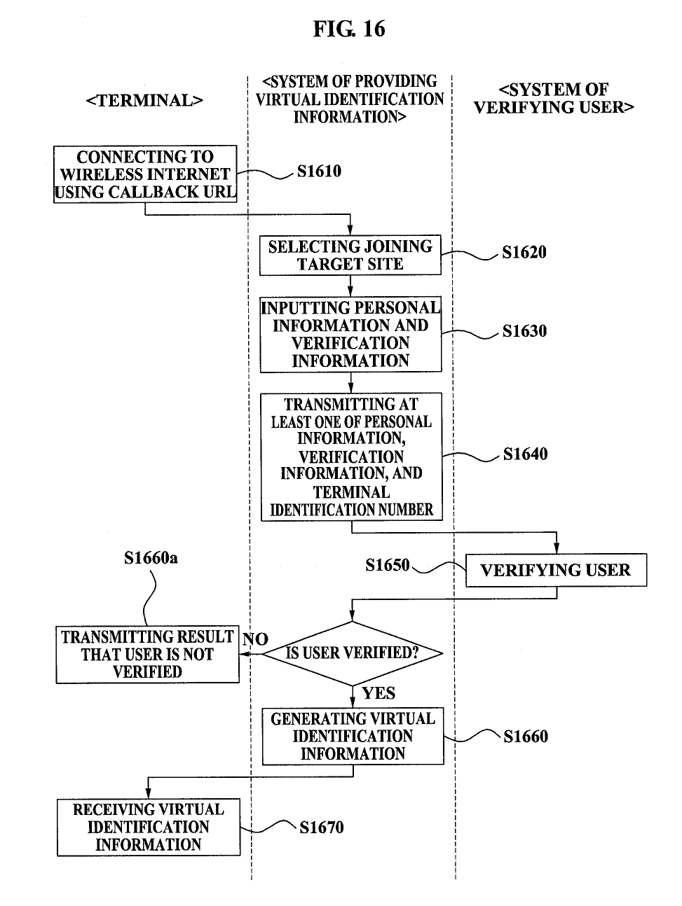

As illustrated in FIG. 16, unlike FIG. 9, FIG. 16 is a flowchart illustrating connecting to a wireless Internet using a callback URL of a message, having been received from a joining target server, and inputting personal information and verification information.

In operation S1610, the terminal 710 connects to the wireless Internet using the callback URL of the message, having been received from a joining target server of the joining target site. For this, the user connects to the joining target server, requests virtual identification information, and receives the message including the callback URL from the joining target server. The callback URL is Internet connection information capable of directly connecting to the system of providing virtual identification information 800. Accordingly, the terminal 710 may connect to a web associated with the system of providing virtual identification information 800 in the message. Also, the callback URL may include a joining target site name of the joining target server or an identifier of the joining target site.

Since descriptions regarding operations S1620 through S1670 are similar to descriptions regarding operations of FIG. 15, the descriptions regarding operations S1620 through S1670 will be omitted.

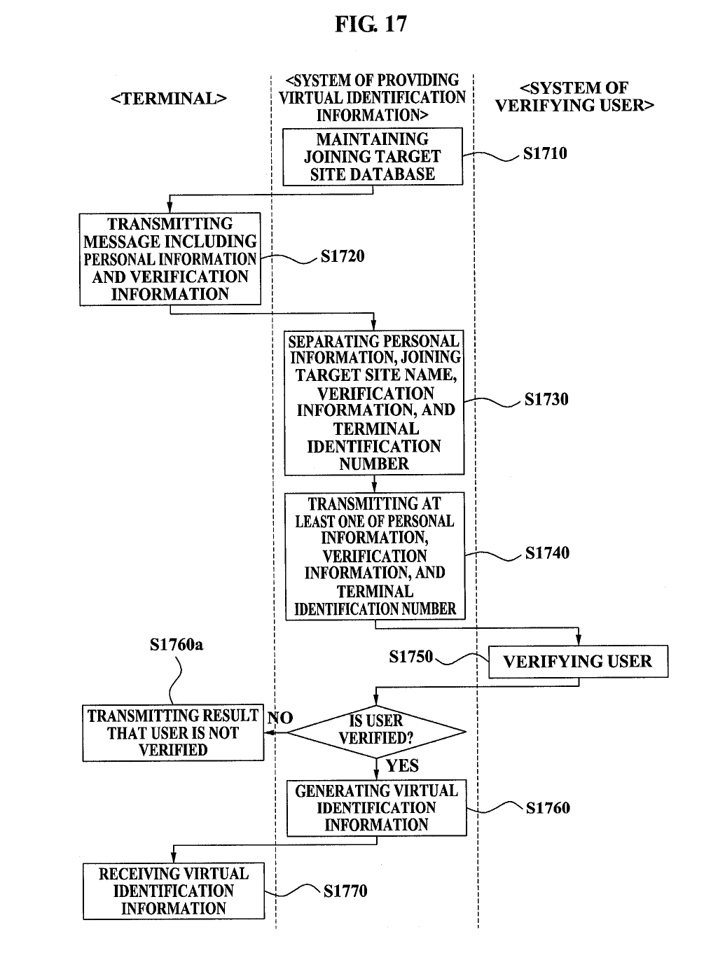

As described in FIG. 17, unlike FIG. 9, FIG. 17 is a flowchart illustrating establishing a receiving number as a joining target site number, and transmitting a message when transmitting the message. In this instance, the joining target site is not included in the message, and personal information and verification information are included in the message.

In operation S1710, the system of providing virtual identification information 800 stores a joining target site number in a joining target site database 880, in association with the joining target site name. The joining target site number is an identification number which is allocated to each joining target site, and the system of providing virtual identification information 800 identifies the joining target site number to check the joining target site name.

In operation S1720, the terminal 710 establishes a receiving number as the joining target site number, and transmits the message including the personal information and the verification information to the system of providing virtual identification information 800.

In operation S1730, the message receiving unit 810 of the system of providing virtual identification information 800 receives the message including the personal information and the verification information, and separates the personal information, a number of the terminal 710, and the verification information from the message.

Since descriptions regarding operations S1740 and S1750 are similar to descriptions regarding operations S930 through S940, the descriptions regarding operations S1540 through S1570 will be omitted.

In operation S1760, the system of providing virtual identification information 800, when the user verification is checked, extracts the joining target site name from the joining target site database 880 to generate virtual identification information using the joining target site name, the terminal identification number, and the personal information. The system of providing virtual identification information 800 transmits the virtual identification information to the terminal 710, and the terminal 710 receives the virtual identification information in operation S1770.

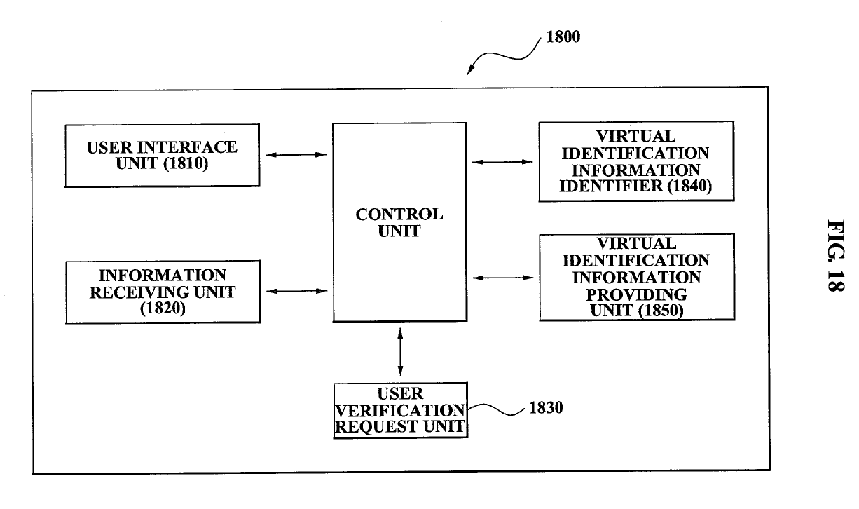

FIG. 18 is a block diagram illustrating a configuration of a system of providing virtual identification information 1800 according to another embodiment of the present invention.

As illustrated in FIG. 18, the system of providing virtual identification information 1800 according to the other embodiment of the present invention includes a user interface unit 1810, an information receiving unit 1820, a user verification request unit 1830, a virtual identification information generation unit 1840, and a virtual identification information providing unit 1850.

The user interface unit 1810 provides a user interface for inputting information. The user interface is provided for a user to write down personal information, a joining target site name, a terminal identification number, and verification information written on a paper application.

The information receiving unit 1820 is inputted with the personal information, the target site name, the terminal identification number, and the verification information via the user interface. The information receiving unit 1820 is, for an operator, to register the personal information, the target site name, the terminal identification number, and the verification information on a paper application to a system of providing virtual identification information 1800. As an example, when there are ten applications inputted by ten users, an operator inputs ten personal information, a joining target site name, a terminal identification number, and verification information via the information receiving unit 1820.

The user verification unit 1830 transmits a terminal identification number of the terminal and the verification information to request the user verification system 720 to verify the user. The user verification unit 1830 requests the user verification system 720 to verify the user, and the user verification system 720 is one of a server of a mobile communication company, a server of a credit card company, a server of a bank, and a server of verifying personal identity.

The virtual identification information generation unit 1840 generates virtual identification information using the personal information, the terminal identification number, and the joining target site name when the user is verified. As described above, the virtual identification information generation unit 1840 combines the personal information, the terminal identification number, and the joining target site name to generate virtual identification information using a predetermined Hash code generation scheme, or a serial scheme according to an issuing time. Also, the virtual identification information generation unit 1840 may generate the virtual identification information using the verification details database 850 or the joining target site database 880.

The virtual identification information providing unit 1850 provides each user with the generated virtual identification information.

As described above, according to the present invention, virtual identification information may be generated offline in addition to online using information inputted by a user, consequently the virtual identification information may be easily generated regardless of place, and the user may join an Internet site as a member using the generated virtual identification information.

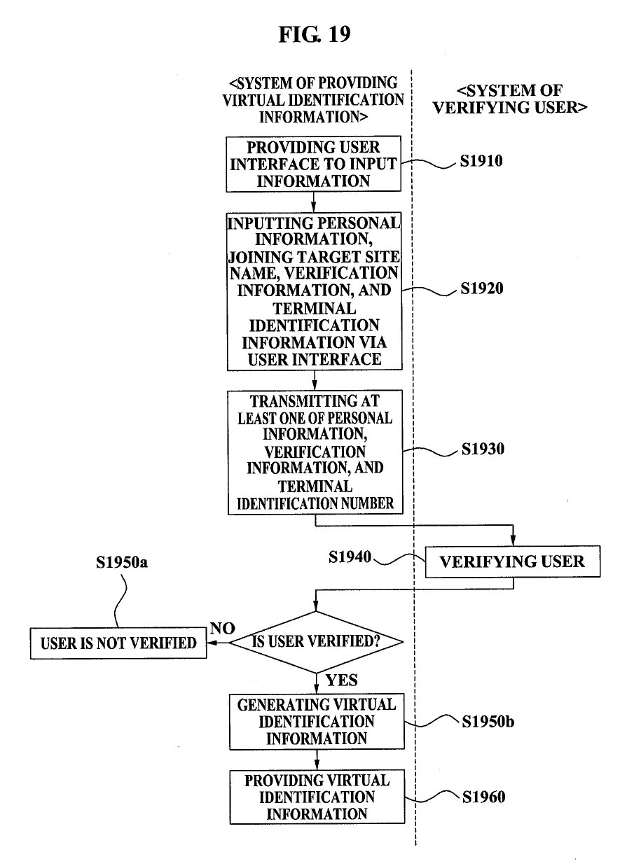

FIG. 19 is a flowchart illustrating a method of providing virtual identification information according to still another embodiment of the present invention.

In operation S1910, the user interface unit 1810 of the system of providing virtual identification information 1800 provides a user interface to input information.

In operation S1920, the information receiving unit 1820 is inputted personal information, a joining target site name, a terminal identification number, and verification information via the system of providing virtual identification information 1800.

In operation S1930, the user verification request unit 1830 transmits at least one of the personal information, the joining target site name, the terminal identification number, and the verification information to request the user verification unit 720 to verify a user.

In operation S1940, the user verification unit 720 receives at least one of the personal information, the joining target site name, the terminal identification number, and the verification information from the system of providing virtual identification information 1800 to verify the user. The user verification unit 720 transmits a result of the verification to the system of providing virtual identification information 1800.

In operation S1950b, the virtual identification information generation unit 1840 generates virtual identification information using the personal information, the terminal identification number, and the joining target site name when the user is verified. When the user is not verified, it is informed to each user that the user is not verified in operation S1950a.

In operation S1960, the virtual identification information generation unit 1850 provides the user with the generated virtual identification information.

The method of providing virtual identification information according to the above-described embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

### INDUSTRIAL APPLICABILITY

As described above, according to the present invention, an environment which can securely perform various control processes being required by a user using virtual identification information, having being generated by transforming personal information of the user, may be provided without directly exposing the personal information.

Also, according to the present invention, damages of personal information being easily stolen may be reduced since virtual identification information is inputted instead of actual personal information, which is required to be inputted when verifying a personal identification online.

Also, according to the present invention, a control process may be securely performed using virtual identification information offline as well as online since the virtual identification information is generated using an identification code, which is allocated to a member store, a terminal of the member store, a server of the member store, or a service of the member store offline, and the generated virtual identification code is provided to a user.

1. A method for providing virtual identification information, comprising:
exposing an output medium having an identification code to a user being associated with a request of the user;
receiving personal information of the user along with the identification code from the user;
generating virtual identification information using the inputted identification code and personal information, and transmitting the generated virtual identification information to the user; and
performing a predetermined control process which corresponds to a request of the user as a result that the transmitted virtual identification information is inputted to the exposed output medium by the user.

2. The method of claim 1, further comprising:
allocating an identification code to a terminal of a member store in response to a request for the identification code from the member store, the terminal of the member store, or a server of the member store; and
maintaining an identification code database which stores the allocated identification code in correspondence to member store information about the terminal of the member store.

3. The method of claim 2, wherein the generating of the virtual identification information using the inputted identification code and the personal information, and transmitting the generated virtual identification information to the user comprises:
searching for member store information corresponding to the inputted identification code from the identification code database; and
combining the retrieved member store information with the personal information to generate the virtual identification information.

4. The method of claim 2, wherein, when the identification code and the personal information are inputted via a terminal of the user, the generating of the virtual identification information using the inputted identification code and the personal information, and transmitting the generated virtual identification information to the user comprises:
checking an identification number of the terminal of the user;
searching for the member store information corresponding to the inputted identification code from the identification code database; and
generating the virtual identification information by combining the retrieved member store information, the personal information, and the verified identification number.

5. The method of claim 1, further comprising:
maintaining an identification information database which stores the generated virtual identification information in correspondence to member store information associated with the identification code,
wherein the performing of the control process comprises:
determining whether the inputted virtual identification information is verified, by referring to the identification information database; and
performing the control process when the verification is performed as a result of the determination.

6. The method of claim 5, wherein the determining whether the inputted virtual identification is verified comprises:
determining whether the member store information associated with the output medium, where the virtual identification information is inputted, corresponds to my member store information in the identification information database.

7. The method of claim 1, wherein the identification code is a special service code which is allocated to the terminal of the member store where the request of the user is performed, or is a terminal identifier.

8. The method of claim 7, wherein the special service code uses at least one of a short message service mobile originate (SMS MO) service, wireless Internet numbers for contents (WINC), or an audio response system (ARS).

9. The method of claim 1, wherein the personal information is to verify that a user is legitimate, and corresponds to at least one of a social identification (ID) number, a credit card number, a driver's license number, a tax payment number, a medical insurance number, or a social security number of the user.

10. The method of claim 1, wherein the virtual identification number is generated to have a same format as at least one of a social ID number, a credit card number, a driver's license number, a tax payment number, a medical insurance number, or a social security number of the user.

11. The method of claim 1, wherein the virtual identification information is used by being limited to any one of a member store, a terminal of the member store, a server of the member, or a service of the member store, according to member store information and the personal information of the user.

12. The method of claim 1, wherein the receiving of the personal information of the user along with the identification code receives the personal information of the user using at least one of an SMS, the SMS MO service, a Web, a socket, the WINC, a callback-uniform resource locator (URL), a wireless application protocol (WAP), a WAP push, an ARS, a speech, or a written letter.

13. The method of claim 1, wherein the generating of the virtual identification information using the inputted identification code and the personal information, and transmitting the generated virtual identification information to the user transmits the virtual identification information using at least one of an SMS, an SMS MO service, a WEB, a SOCKET, the WINC, a callback-URL, a wireless application protocol (WAP), a WAP PUSH, an ARS, a speech, or a written letter.

14. The method of claim 1, further comprising:
maintaining, after the performing of the control process, the virtual identification information with respect to any one of the member store, the terminal of the member store, the server of the member, or the service of the member store according to the member store information or the personal information of the user.

15. A computer-readable storage medium storing a program for implementing the providing method of claim 1.

16. A system of providing virtual identification information, comprising:
an output control unit exposing an output medium having an identification code to a user being associated with a request of the user;
an information receiving unit receiving personal information of the user along with the identification code from the user;
an identification information generation unit generating virtual identification information using the inputted identification code and personal information, and transmitting the generated virtual identification information to the user; and
a control process unit performing a predetermined control process which corresponds to a request of the user as a result that the transmitted virtual identification information is inputted to the exposed output medium by the user.

17. The system of claim 16, further comprising:
a code allocation unit allocating an identification code to a terminal of a member store in response to a request for the identification code from a server of the member store; and
an identification code database maintaining an identification code which stores the allocated identification code in correspondence to member store information about the terminal of the member store.

18. The system of claim 17, wherein the identification information generation unit searches for member store information corresponding to the inputted identification code from the identification code database, and combines the retrieved member store information with the personal information to generate the virtual identification information.

19. The system of claim 17, wherein, when the identification code and the personal information are inputted via a terminal of the user, the identification information generation unit checks an identification number of the terminal of the user, searches for the member store information corresponding to the inputted identification code from the identification code database, and generates the virtual identification information by combining the retrieved member store information, the personal information, and the verified identification number.

20. The system of claim 16, further comprising:
an identification information database maintaining identification information which stores the generated virtual identification information in correspondence to member store information associated with the identification code,
wherein the control process unit determines whether the inputted virtual identification information is verified by referring to the identification information database, and performs the control process when the verification is performed as a result of the determination.

21. The system of claim 20, wherein the control process unit determines whether the member store information associated with the output medium, where the virtual identification information is inputted, corresponds to my member store information in the identification information database.

22. The system of claim 16, wherein the identification code is a special service code which is allocated to the terminal of the member store where the request of the user is performed, or is a terminal identifier.

23. The system of claim 22, wherein the feature code uses at least one of a short message service mobile originate (SMS MO) service, wireless Internet numbers for contents (WINC), or an audio response system (ARS).

24. The system of claim 16, wherein the personal information is to verify that a user is legitimate, and corresponds to at least one of a resident registration number, a credit card number, a driver's license number, a tax payment number, a medical insurance number, or a social security number of the user.

25. The system of claim 16, wherein the virtual identification information is used by limiting to any one of a member store, a terminal of the member store, a server of the member, or a service of the member store, according to member store information and the personal information of the user.

26. The system of claim 16, wherein the control process unit maintains, after the performing of the control process, the virtual identification information with respect to any one of the member store, a terminal of the member store, a server of the member, or a service of the member store according to member store information or the personal information of the user.

27. The system of claim 16, wherein the virtual identification number is generated to have a same format as at least one of a social ID number, a credit card number, a driver's license number, a tax payment number, a medical insurance number, or a social security number of the user.

28. The system of claim 16, wherein the information receiving unit receives the personal information of the user using at least one of an SMS, an SMS MO service, a WEB, a socket, the WINC, a callback-URL, a wireless application protocol (WAP), a WAP push, an ARS, a speech, or a written letter.

29. The system of claim 16, wherein the identification information generation unit transmits the virtual identification information using at least one of an SMS, an SMS MO service, a WEB, a SOCKET, a WINC, a callback-URL, a wireless application protocol (WAP), a WAP PUSH, an ARS, a speech, or a written letter.
